(19) United States
(12) Patent Application Publication
(10) Pub. No.: US 2009/0044191 A1
(43) Pub. Date: Feb. 12, 2009

(54) METHOD AND TERMINAL DEVICE FOR EXECUTING SCHEDULED TASKS AND MANAGEMENT TASKS

(75) Inventors: Xiaoqian Chai, Shenzhen (CN); Kepeng Li, Shenzhen (CN); Xiaoyi Dong, Shenzhen (CN); Jiangshui He, Shenzhen (CN)

Correspondence Address: DARBY & DARBY P.C., P.O. BOX 770, Church Street Station, New York, NY, 10008-0770, US

(73) Assignee: HUAWEI TECHNOLOGIES CO., LTD., Shenzhen (CN)

(21) Appl. No.: 12/178,829

(22) Filed: Jul. 24, 2008

Related U.S. Application Data
(63) Continuation of application No. PCT/CN2006/002704, filed on Oct. 16, 2006.

(30) Foreign Application Priority Data
Jan. 24, 2006 (CN) 200610002214.8

(51) Int. Cl. G06F 9/46

(52) U.S. Cl. 718/102

(57) ABSTRACT

An OMA DM-based method for executing a scheduled task, includes the steps of: storing terminal resource capabilities required for executing each scheduled task in a terminal device; and executing the scheduled task after the terminal device determines that the current resource capabilities are sufficient for executing the scheduled task while it is ready to execute the scheduled task. An OMA DM-based terminal device for practicing this method includes a primary storing unit for storing the terminal resource capabilities, a judging unit for determining whether current resource capabilities of the terminal device meet the terminal resource capabilities that are required for executing the scheduled task, and a primary executing unit for executing the scheduled when the judging unit determines that the current resource capabilities are sufficient. By determining whether current resource capabilities are sufficient before executing, the success of scheduled tasks and management tasks in a terminal device is improved.

### CROSS-REFERENCE TO RELATED APPLICATION

This application is a continuation under 35 U.S.C. § 120 of International Application PCT/CN2006/002704, filed Oct. 16, 2006, which claims the benefit of Chinese Patent Application Nos. 200610002214.8, filed Jan. 24, 2006, each of which is incorporated by reference in its entirety herein. The International Application was published in Chinese on Aug. 2, 2007 as WO 2007/085157 A1 under PCT Article 21(2).

### FIELD OF THE INVENTION

The present invention relates to the Open Mobile Alliance (OMA) Device Management (DM) technologies, and in particular, to an OMA DM-based method for executing scheduled tasks and management tasks, a method for obtaining terminal resource capabilities, and the corresponding DM server and terminal device.

### BACKGROUND OF THE INVENTION

The OMA DM protocol is a technology for managing, diagnosing and maintaining mobile terminal devices. It manages terminal devices over the air (OTA), and the management operations on terminal devices include: setting parameters of a terminal device, updating firmware, installing and upgrading software, and collecting and handling device error and event information. The mobile terminal devices managed by the OMA DM protocol include mobile station, palm computer, notebook computer, embedded device and vehicle-mounted systems, without limitation to any other mobile terminal devices.

Currently, in the DM protocol, a terminal device executes the management tasks delivered by the DM server in two ways:

(1) The DM server delivers a management task to the terminal device, the terminal device executes the task to perform installation and storage, and the execution conditions for triggering the management task are set in the management task delivered by the DM server. Subsequently, the terminal device keeps monitoring whether the execution conditions are met, and executes the management task when the execution conditions are met. Generally, a management task in this mode is called a “scheduled task” from the perspective of the terminal device.

When executing the scheduled task, however, the terminal device only monitors whether the execution conditions for triggering the scheduled task are met and executes the scheduled task as soon as the conditions are met, without considering whether the resources are enough for processing the scheduled task. Suppose that a scheduled task delivered by the DM server to the terminal device is: at a future time, the DM server delivers update software according to the request of the terminal device and then the terminal device installs the update software delivered by the DM server. In this case, the condition for executing the scheduled task delivered by the DM server is: the terminal device requests to download the update software from the DM server at the specified time. Afterward, the terminal device keeps monitoring whether the execution condition is met, namely, whether the specified time arrives. As soon as the execution condition is met, the terminal device requests the DM server to deliver the update software and installs the software delivered by the DM server. Nevertheless, it is possible that the terminal device has deficient memory for executing the task at the moment, and the installation of the update software delivered by the DM server fails. Consequently, the execution of this scheduled task fails. Suppose a scheduled task delivered by the DM server to the user terminal is: at a specified time, the user terminal sorts its log records, and reports the sorted log records to the DM server. In this case, the terminal device sorts its log records as soon as the specified time arrives. Nevertheless, it is possible that the battery of the terminal device is deficient at the moment, the terminal device shuts down abruptly in the process of sorting the log records, and thus the execution of this scheduled task fails.

Therefore, in the process of executing a scheduled task, if the terminal device only monitors whether the execution conditions for triggering the scheduled task are met and executes the scheduled task as soon as the conditions are met without considering whether the resources are sufficient for processing the scheduled task, the execution of the scheduled task may fail, thus reducing the success ratio of executing scheduled tasks.

(2) The DM server delivers a management task to the terminal device directly, and the terminal device executes the management task upon receiving it. Similarly, in this mode, if the DM server delivers the management task without considering the current resource conditions of the terminal device, the terminal device may fail to finish the management task delivered by the DM server, thus reducing the success ratio of executing the management tasks delivered by the DM server.

### SUMMARY OF THE INVENTION

The present invention primarily proposes an OMA DM-based method for executing scheduled tasks, so as to improve the success ratio of executing scheduled tasks in a terminal device.

Accordingly, the present invention also proposes an OMA DM-based terminal device for the purpose of solving the foregoing primary technical issue.

Secondly, the present invention proposes an OMA DM-based method for executing management tasks, so as to improve the success ratio of executing management tasks delivered by a DM server to a terminal device.

Accordingly, the present invention also proposes a DM server to solve the foregoing secondary technical issue.

Thirdly, the present invention proposes an OMA DM-based method for obtaining terminal resource capabilities and proposes a terminal device.

To solve the foregoing issues, the invention proposes the following technical schemes:

An OMA DM-based method for executing a scheduled task includes: storing terminal resource capabilities required for executing each scheduled task in a terminal device; by the terminal device, executing the scheduled task after the terminal device determines that the current resource capabilities are sufficient for executing the scheduled task while it is ready to execute the scheduled task.

Preferably, a DM server generates the terminal resource capabilities required for executing the scheduled task, and delivers the generated terminal resource capabilities to the user terminal for storage.

Preferably, the terminal device stores the terminal resource capabilities required for executing the scheduled task in the form of a DM tree.

Preferably, the method also includes this step: in the OTA mode, the DM server updates the terminal resource capability information stored on each node in the DM tree.

Preferably, the method also includes this step: the terminal device postpones executing the scheduled task if it determines that the current resource capabilities are deficient for executing the scheduled task while it is ready to execute the scheduled task; and executes the scheduled task if its resource capabilities are sufficient for executing the scheduled task.

Preferably, the method also includes this step: the terminal device rejects execution of the scheduled task if it determines that the current resource capabilities are deficient for executing the scheduled task while it is ready to execute the scheduled task.

Preferably, the method also includes this step: the terminal device executes the scheduled task if it determines that the current resource capabilities are deficient for executing the scheduled task while it is ready to execute the scheduled task; and adjusts its resource capabilities to ensure completion of the scheduled task.

Preferably, the method also includes this step: the terminal device stores a group of different processing strategies beforehand; prompts the user that the current resource capabilities of the terminal device are deficient for executing the scheduled task if the terminal device determines that the current resource capabilities are deficient for executing the scheduled task while it is ready to execute the scheduled task, and prompts the user about the processing strategies stored beforehand; the terminal device handles the scheduled task properly according to the processing strategy selected by the user.

Preferably, the judgment process includes: the terminal device obtains its current resource capabilities; reads the pre-stored terminal resource capabilities required for executing the scheduled task; and compares the obtained current resource capabilities and the read terminal resource capabilities required for executing the scheduled task to judge whether the current resource capabilities are sufficient for executing the scheduled task.

Preferably, the method also includes this step: the terminal device queries the pre-stored terminal resource capabilities required for executing the scheduled task through a user interface before execution of the scheduled task; prompts the user about the query results; and adjusts the current resource capabilities according to the command input by the user.

An OMA DM-based terminal device includes: a primary storing unit, adapted to store the terminal resource capabilities required for executing each scheduled task; a judging unit, adapted to judge whether the current resource capabilities meet the terminal resource capabilities that are required for executing the scheduled task and stored in the primary storing unit while the terminal device is ready to execute the scheduled task; and a primary executing unit, adapted to execute the scheduled task when the judging unit determines the current resource capabilities are sufficient.

Preferably, the terminal device also includes a postponing unit, adapted to postpone executing the scheduled when the judging unit determines that the current resource capabilities are deficient, and execute the scheduled task when the resource capabilities of the terminal device are sufficient for executing the scheduled task.

Preferably, the terminal device also includes a rejecting unit, adapted to reject execution of the scheduled task when the judging unit determines that the resource capabilities are deficient.

Preferably, the terminal device also includes a secondary executing unit, adapted to execute the scheduled task when the judging unit determines that the resource capabilities are deficient, and adjust the resource capabilities of the terminal device to ensure completion of the scheduled task.

Preferably, the terminal also includes: a secondary storing unit, adapted to pre-store a group of different processing strategies; a primary prompting unit, adapted to prompt the user that the current resource capabilities of the terminal device are deficient for executing the scheduled task when the judging unit determines that the resource capabilities are deficient and to prompt the user about the processing strategies pre-stored by the secondary storing unit; and a processing unit, adapted to process the scheduled task according to the processing strategy selected by the user.

Preferably, the primary storing unit stores the terminal resource capabilities required for executing the scheduled task in the form of a DM tree.

Preferably, the judging unit includes: an obtaining subunit, adapted to obtain the current resource capabilities of the terminal device; a reading subunit, adapted to read the terminal resource capabilities required for executing the scheduled task and pre-stored in the primary storing unit; a comparing subunit, adapted to compare the resource capabilities obtained by the obtaining subunit with the terminal resource capabilities read by the reading subunit to determine whether the current resource capabilities of the terminal device are sufficient for executing the scheduled task.

Preferably, the terminal device also includes: a querying unit, adapted to query the terminal resource capabilities required for executing the scheduled task and pre-stored in the primary storing unit through a user interface while the terminal device is not executing the scheduled task; a secondary prompting unit, adapted to prompt the user about the query results of the querying unit; and an adjusting unit, adapted to adjust the current resource capabilities of the terminal device according to the input of the user.

An OMA DM-based method for executing a management task includes: by a DM server, configuring terminal resource capabilities required for executing the management task; commanding the terminal device to report the current resource capabilities when intending to deliver the management task to the terminal device; by the terminal device, responding to the command issued by the DM server and obtaining its current resource capabilities and reporting them to the DM server; by the DM server, delivering the management task to the terminal device for execution when it determines that the resource capabilities reported by the terminal device are sufficient for executing the management task.

Preferably, the terminal device interprets and responds to the command issued by the DM server by expanding the nodes of the DM tree stored in the terminal device and storing the corresponding terminal resource capability identifiers on the expanded nodes.

Preferably, the method also includes this step: the DM server adjusts the management task to be delivered so that the current resource capabilities of the terminal device are sufficient for executing the management task correctly after determining that the resource capabilities reported by the terminal device are deficient; and delivers the adjusted management task to the terminal device for execution.

Preferably, the method also includes this step: the DM server notifies the terminal device that the current resource capabilities do not support execution of the management task to be delivered after determining that the resource capabilities reported by the terminal device are deficient for executing the management task.

A DM server includes: a configuring unit, adapted to configure terminal resource capabilities required for executing a management task; a command unit, adapted to command the terminal device to report the current resource capabilities when intending to deliver a management task to the terminal device; a judging unit, adapted to judge whether the resource capabilities reported by the terminal device are sufficient for executing the management task; and a primary management task delivering unit, adapted to deliver the management task to the terminal device when the judging unit determines that the resource capabilities are sufficient.

Preferably, the DM server also includes: a management task adjusting unit, adapted to adjust the management task to be delivered so that the current resource capabilities of the terminal device are sufficient for executing the management task correctly when the judging unit determines that the resource capabilities are deficient; and a secondary management task delivering unit, adapted to deliver the management task adjusted by the management task adjusting unit to the terminal device for execution.

Preferably, the DM server also includes a notifying unit, adapted to notify the terminal device that the current resource capabilities do not support execution of the management task to be delivered after the judging unit determines that the resource capabilities are deficient.

An OMA DM-based method for executing a management task includes: by a DM server, configuring terminal resource capabilities required for executing the management task; delivering the management task and the terminal resource capabilities required for executing the management task to the terminal device; by the terminal device, obtaining the current resource capabilities when receiving the management task and the terminal resource capabilities required executing the management task; and executing the management task when determining that the current resource capabilities are sufficient for executing the management task.

Preferably, the method includes this step: the terminal device rejects execution of the management task when determining that the current resource capabilities are deficient for executing the management task; and reports the message of rejecting execution of the management task to the DM server.

Preferably, the method also includes this step: the terminal device executes the management task if it determines that the current resource capabilities are deficient for executing the management task; and adjusts its resource capabilities to ensure completion of the management task.

An OMA DM-based terminal device includes: a receiving unit, adapted to receive a management task delivered by a DM server and the terminal resource capabilities required for executing the management task; an obtaining unit, adapted to obtain the current resource capabilities of the terminal device after the receiving unit receives the management task and the terminal resource capabilities required for executing the management task; a judging unit, adapted to judge whether the current resource capabilities obtained by the obtaining unit meet the terminal resource capabilities that are required for executing the management task and received by the receiving unit; and a primary executing unit, adapted to execute the management task when the judging unit determines that the current resource capabilities are sufficient.

Preferably, the terminal device also includes: a rejecting unit, adapted to reject execution of the management task when the judging unit determines that the resource capabilities are deficient; and a reject message reporting unit, adapted to report the message of rejecting execution of the management task to the DM server.

Preferably, the terminal device also includes a secondary executing unit, adapted to execute the management task when the judging unit determines that the resource capabilities are deficient, and adjust the resource capabilities of the terminal device to ensure completion of the management task.

An OMA DM-based method for obtaining terminal resource capabilities includes: expanding the nodes of a DM tree in a terminal device, and storing the corresponding terminal resource capability identifiers on the expanded nodes; by the device terminal, obtaining a terminal resource capability value from the lower-layer system through an interface provided by the lower-layer system based on the terminal resource capability identifier stored on the corresponding expanded node in the DM tree.

An OMA DM-based terminal device includes: a unit adapted to expand the nodes of a DM tree in the terminal device and store the corresponding terminal resource capability identifiers on the expanded nodes; and a unit adapted to obtain a terminal resource capability value from the lower-layer system through an interface provided by the lower-layer system based on the terminal resource capability identifier stored on the corresponding expanded node in the DM tree.

One or more embodiments of the invention as described herein are capable of providing the following benefits:

According to the present invention, the terminal resource capabilities required for executing a scheduled task or a management task are configured beforehand. Therefore, when the terminal device is ready to execute a scheduled task or a management task, the terminal device or the DM server obtains the current resource capabilities of the terminal device first, and judges whether the current resource capabilities of the terminal device are sufficient for executing the scheduled task or management task. The terminal device executes the scheduled task or management task only if the current resource capabilities of the terminal device are sufficient for executing the scheduled task or management task; otherwise, the terminal device prompts the user to adjust or handle the terminal device properly before executing the scheduled task or management task, thus improving the success ratio of executing scheduled tasks or management tasks in the terminal device.

### BRIEF DESCRIPTION OF THE DRAWINGS

The invention will become more readily apparent from the Detailed Description of the Invention which proceeds with reference to the drawings, in which:

FIG. 1 provides a flowchart illustrating an OMA DM-based method for executing a scheduled task in an embodiment of the invention;

FIG. 2 provides a flowchart illustrating how a DM server delivers a portion of terminal resource capabilities required for executing a scheduled task to a terminal device, where the portion is higher than the preset terminal capability threshold;

FIG. 3 shows a data structure of the terminal resource capability information stored in a terminal device according to the OMA DM-based method for executing a scheduled task in an embodiment of the invention;

FIG. 4 shows a DM subtree storage structure after the terminal resource capabilities required for executing a scheduled task are added on a node in the DM tree during the practice of the method for executing a scheduled task in an embodiment of the invention;

FIG. 5 shows the composition of the first type of OMA DM-based terminal device in an embodiment of the invention;

FIG. 6 shows a schematic diagram illustrating elements of a judging unit in an OMA DM-based terminal device in an embodiment of the invention;

FIG. 7-FIG. 9 show schematic diagrams respectively illustrating elements of three types of OMA DM-based terminal devices for several embodiments of the invention;

FIG. 10 shows a schematic diagram illustrating elements of an OMA DM-based terminal device in an embodiment of the invention;

FIG. 11 shows a schematic diagram illustrating elements of an OMA DM-based terminal device in an embodiment of the invention, where the user can query the terminal resource capabilities required for executing a scheduled task anytime;

FIG. 12 shows a sequence diagram illustrating a first OMA DM-based method for executing a management task in an embodiment of the invention;

FIG. 13 shows a sequence diagram illustrating a second OMA DM-based method for executing a management task in an embodiment of the invention;

FIG. 14 shows a schematic diagram illustrating elements of another type of OMA DM-based terminal device in an embodiment of the invention;

FIG. 15 shows a schematic diagram illustrating elements of another type of OMA DM-based terminal device in an embodiment of the invention; and

FIG. 16 shows a schematic diagram illustrating element of another type of OMA DM-based terminal device in an embodiment of the invention.

### DETAILED DESCRIPTION OF THE INVENTION

Considering that in the related art, a terminal device disregards whether the current resource capabilities are sufficient for executing the management task or scheduled task delivered by a DM server before executing the management task or scheduled task, which reduces the success ratio of executing management tasks and scheduled tasks in the terminal device, the present invention provides the following method:

Before executing a management task or a scheduled task, the terminal device obtains its current resource capability information, and judges whether the current resource capabilities are sufficient for executing the management task or scheduled task. If the resource capabilities are sufficient, the terminal device executes the management task or scheduled task immediately. If the resource capabilities are deficient, the terminal device prompts the user to adjust the current resource capabilities of the terminal device so that they are sufficient for executing the management task or scheduled task delivered by the DM server.

The technical schemes of the invention and their benefits are hereinafter described in detail with reference to several preferred embodiments and the accompanying drawings.

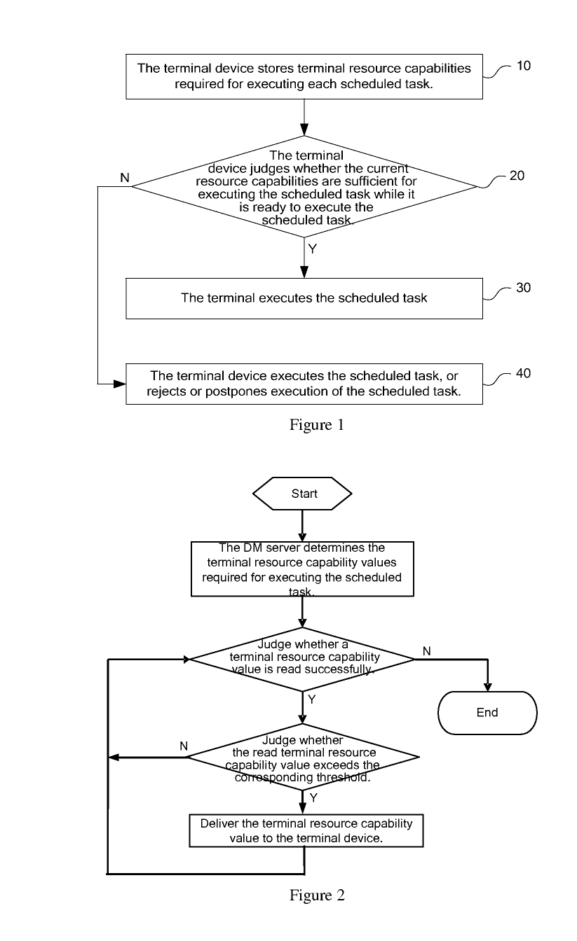

FIG. 1 shows the flowchart of an OMA DM-based method for executing a scheduled task, including the following blocks:

Block 10: A terminal device stores the terminal resource capabilities required for executing each scheduled task delivered by a DM server.

In this block, the DM server may generate the terminal resource capabilities required for executing the scheduled task, and deliver the generated terminal resource capabilities to the user terminal for storage. Moreover, the DM server may preset a group of terminal resource capability thresholds, and deliver a specific portion of the generated terminal resource capabilities to the terminal device which exceed corresponding ones of the group of terminal resource capability thresholds. That is, the DM server predefines a group of terminal resource capability thresholds. If one of the terminal resource capabilities required for executing a scheduled task in the future exceeds the corresponding terminal resource capability threshold, the DM server delivers this terminal resource capability parameter value to the terminal device.

FIG. 2 shows how the DM server delivers a portion of the terminal resource capabilities required for executing a scheduled task to the terminal device, where the portion is higher than the preset terminal capability threshold. Through a SyncML message, the DM server delivers the terminal resource capabilities required for executing a scheduled task to the terminal device. The specific delivery process is described in the relevant OMA DM protocol.

The terminal resource capabilities addressed by the present invention may include but are not limited to at least one of the following attributes:

free memory required for the terminal device to execute a scheduled task (marked as “Memory”);

free electricity required for the terminal device to execute a scheduled task (marked as “Electricity”);

application tool information required for the terminal device to execute a scheduled task (marked as “Tool”);

signal strength required for the terminal device to execute a scheduled task (marked as “Signal_Strength”); and

local time information required for the terminal device to execute a scheduled task (marked as “LocalTime”).

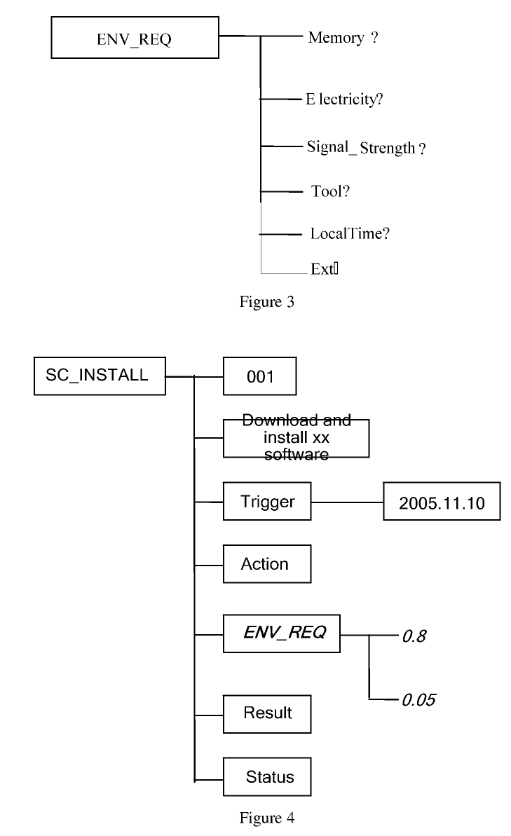

The terminal device may store the terminal resource capabilities required for executing a scheduled task in the form of a DM tree. FIG. 3 shows the storage structure of terminal resource capability information stored in the terminal device according to an OMA DM-based method for executing a scheduled task in an embodiment of the invention. In this figure, the terminal device stores the terminal resource capabilities required for executing a scheduled task, namely, “ENV_REQ” (including these nodes: “Memory”, “Electricity”, “Tool” and “Signal_Strength”) in the form of a DM tree. The nodes in this DM tree have the following meanings:

<ENV_REQ>

| Tree Node | Format | Minimum Access Rights | Value |
|---|---|---|---|
| One | Node | Get | N/A |

This node represents the terminal resource capabilities required for executing the scheduled task;

<ENV_REQ/Memory>

| Tree node | Format | Minimum access rights | Value |
|---|---|---|---|
| ZeroOrOne | Int | Get | N/A |

This leaf node represents the required memory size in the terminal resource capability information;

<ENV_REQ/Electricity>

| Tree node | Format | Minimum access rights | Value |
|---|---|---|---|
| ZeroOrOne | float | Get | N/A |

This leaf node represents the required electricity volume in the terminal resource capability information;

<ENV_REQ/Signal_Strength>

| Tree node | Format | Minimum access rights | Value |
|---|---|---|---|
| ZeroOrOne | float | Get | N/A |

This leaf node represents the required signal strength in the terminal resource capability information;

<ENV_REQ/Tool>

| Tree node | Format | Minimum access rights | Value |
|---|---|---|---|
| ZeroOrOne | char | Get | N/A |

This leaf node represents the required application tool in the terminal resource capability information;

<ENV_REQ/LocalTime>

| Tree node | Format | Minimum access rights | Value |
|---|---|---|---|
| ZeroOrOne | time | Get | N/A |

This leaf node represents the required local time in the terminal resource capability information;

<ENV_REQ/Ext>

| Tree node | Format | Minimum access rights | Value |
|---|---|---|---|
| ZeroOrOne | Node | Get | N/A |

This node is reserved for future expansion.

In the future, if the DM server is permitted, the terminal resource capability information stored on each node in the DM tree in the terminal device may be updated in the OTA mode. That is, if the DM server is permitted, the node for storing the terminal resource capability information in the DM tree may be updated in the OTA mode, and the DM server may update each node in the DM tree by issuing the SyncML-based Replace command.

Block 20: The terminal device judges whether the current resource capabilities meet the terminal resource capabilities that are required for executing the scheduled task and stored on the corresponding node in the DM tree. If the current resource capabilities meet the terminal resource capabilities that are required for executing the scheduled task, the terminal device performs block 30; if the current resource capabilities do not meet the terminal resource capabilities that are required for executing the scheduled task, the terminal device performs block 40.

The foregoing judgment process of the terminal device may be:

The terminal device obtains its current resource capabilities first, and the terminal device may expand the nodes of the DM tree, store the corresponding terminal resource capability identifiers on the expanded nodes, and then obtain a terminal resource capability value from the lower-layer system through an interface provided by the lower-layer system based on the terminal resource capability identifier stored on the corresponding expanded node in the DM tree. For example, the terminal device may obtain the current available memory size of the terminal device, free electricity and current signal strength from the lower-layer system through an application programming interface (API) provided by the lower-layer system according to the Memory identifier, the Electricity identifier and the Signal_Strength identifier stored in some expanded nodes in the DM tree. Moreover, the terminal device may also expand the nodes of its DM tree, store the corresponding terminal resource capability value directly on an expanded node, and then obtain the corresponding terminal resource capability value directly on the expanded node in the DM tree.

Afterward, the terminal device reads the terminal resource capabilities that are required for executing the scheduled task and stored on the corresponding node in the DM tree. For example, the terminal device may obtain the terminal resource capability information (for example, electricity, memory and signal strength) required for executing the scheduled task from the ENV_REQ node of the scheduled task subtree.

Finally, by comparing the obtained current resource capabilities with the terminal resource capabilities required for executing the scheduled task, the terminal device judges whether the current resource capabilities are sufficient for executing the scheduled task.

Moreover, the terminal device is able to, without limitation, get ready for executing the scheduled task when it detects that the execution conditions for triggering the scheduled task are met.

Block 30: The terminal device chooses to execute the scheduled task immediately.

Block 40: The terminal device handles the scheduled task according to the preset default strategies, which may be but are not limited to the following modes:

(1) The terminal device postpones executing the scheduled task, and subsequently executes the scheduled task as soon as the resource capabilities are sufficient for executing the scheduled task;

(2) The terminal device rejects execution of the scheduled task directly;

(3) The terminal device chooses to execute the scheduled task immediately, and adjusts its resource capabilities to ensure completion of the scheduled task;

(4) The terminal device may store a group of different processing strategies beforehand. The processing strategies include but are not limited to postponing executing the scheduled task, rejecting execution of the scheduled task and executing the scheduled task.

Subsequently, when the terminal device intends to execute the scheduled task, if the terminal device determines that the current resource capabilities are deficient for executing the scheduled task, the terminal device prompts the user that the current resource capabilities are deficient, and prompts the user about the processing strategies stored beforehand. According to the processing strategy selected by the user, the terminal device handles the scheduled task. If the user chooses to reject execution of the scheduled task, the terminal device rejects execution of the scheduled task upon receiving the command input by the user.

In addition, while the terminal device is in the period of not executing the scheduled task, the terminal device may query the terminal resource capabilities that are required for executing the scheduled task and pre-stored on the node in the DM tree through a user interface (UI), and provide notification to the user about the query results. According to the command input by the user, the terminal device adjusts the current resource capabilities so that the current resource capabilities meet the terminal resource capabilities required for executing the scheduled task and stored on the node in the DM tree. That is, the terminal device may query the terminal resource capabilities required for executing the scheduled task through a UI before triggering the scheduled task. In this way, the terminal device may adjust the current resource capabilities beforehand to ensure that scheduled task can be executed normally after being triggered.

In the following embodiment of the invention, the process of implementing the method for executing a scheduled task is described in detail, supposing that a scheduled task is executed in light of the required terminal resource capabilities in the scenario of downloading a software component:

Suppose a DM server intends to deliver a scheduled task: the task is to download a software component to a terminal device at 2005-11-10 22:00; the size of the component is 0.8 MB, and the predicted download duration is 2-3 minutes:

To ensure that the terminal device executes the scheduled task successfully, the DM server generates and delivers the terminal resource capabilities required for executing the scheduled task while delivering the scheduled task: minimum free memory 0.8 MB, and minimum free electricity 5%.

The DM server uses the SyncML language currently applicable in the OMA DM protocol to deliver the scheduled task and the terminal resource capabilities required for executing the scheduled task. The specific commands are:

```
<Add>
    <CmdID>2</CmdID>
    <Item>
<Target><LocURI>./SC_INSTALL/ENV_REQ/Memory</LocURI>
</Target>
      <Meta>
      <Format xmlns=‘syncml:metinf’>int</Format>
      <Type xmlns=‘syncml:metinf’>text/plain</Type>
      </Meta>
      <Data>0.8</Data>
  </Item>
  <Item>
    <Target>
<LocURI>./ SC_INSTALL/ENV_REQ/Electricity</LocURI>
</Target>
    <Meta>
      <Format xmlns=‘syncml:metinf’>float</Format>
      <Type xmlns=‘syncml:metinf’>text/plain</Type>
    </Meta>
    <Data>0.05</Data>
    </Item>
</Add>
```

Upon receiving the terminal resource capabilities that are required for executing the scheduled task and delivered by the DM server through the foregoing commands, the terminal device stores the terminal resource capabilities on the corresponding node of the DM tree.

FIG. 4 shows the storage structure of a DM subtree formed after the terminal device adds the information about the terminal resource capabilities required for executing the scheduled task onto a node in the DM tree during the practice of the method for executing a scheduled task in an embodiment of the invention.

The terminal device keeps monitoring whether the execution conditions for triggering the scheduled task are met. For example, the terminal device triggers the scheduled task at 2005-11-10, 22:00. The DM agent in the terminal device executes the scheduled task in the following steps:

1. The DM agent queries the ENV_REQ node in the scheduled task management tree, and obtains the information about the terminal resource capabilities required for executing the scheduled task: minimum free memory 0.8 MB, and minimum free electricity 5%.

2. The DM agent obtains the information about the current free memory and free electricity of the terminal device (in a way described above). Suppose that the obtained values are: free memory 0.6 MB, and free electricity 60%.

3. The DM agent compares the queried information about the terminal resource capabilities required for executing the scheduled task with the obtained current resource capability information of the terminal device. The comparison result is: the free memory size in the terminal device is too small currently.

4. The terminal device prompts the user that the free memory is deficient for executing the scheduled task, and asks the user to choose whether to execute the scheduled task immediately, postpone executing the scheduled task or reject execution of the scheduled task.

5. If the user chooses to execute the scheduled task immediately, the user cleans up the memory space of the terminal device in the process of executing the scheduled task (namely, downloading a software component from the DM server) so that the software component can be downloaded successfully.

As seen in the foregoing process, the DM-based method for executing a scheduled task proposed by the present invention enables the terminal device to judge whether the current terminal resource capabilities are sufficient for executing the scheduled task before triggering the scheduled task, and executes the scheduled task when the resource capabilities are sufficient, thus improving the success ratio of executing scheduled tasks.

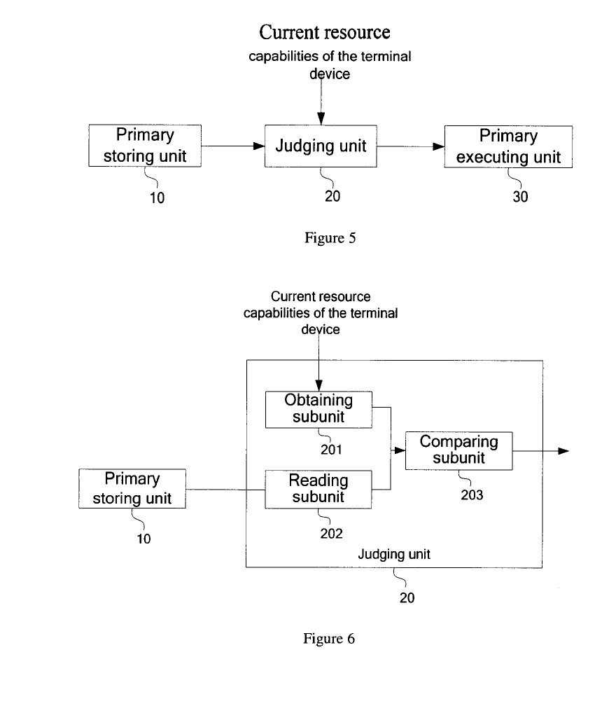

Accordingly, the present invention also provides an OMA DM-based terminal device. FIG. 5 shows the elements of a first type of OMA DM-based terminal device provided in an embodiment of the invention. The composition includes:

a primary storing unit 10, adapted to store the terminal resource capabilities required for executing each scheduled task; and preferentially storing the information about the terminal resource capabilities required for executing the scheduled task in the form of a DM tree;

a judging unit 20, adapted to judge whether the current resource capabilities of the terminal device meet the terminal resource capabilities that are required for executing the scheduled task and stored in the primary storing unit 10 when the terminal device intends to execute the scheduled task; and

a primary executing unit 30, adapted to execute the scheduled task as soon as the judging unit 20 determines that the current resource capabilities are sufficient.

FIG. 6 shows the elements of a judging unit in an OMA DM-based terminal device. The judging unit may further include:

an obtaining subunit 201, adapted to obtain the current resource capability information of the terminal device;

a reading subunit 202, adapted to read the information about the terminal resource capabilities required for executing the scheduled task, which is stored in the primary storing unit 10 beforehand; and

a comparing subunit 203, adapted to compare the information about the resource capabilities obtained by the obtaining unit 201 with the terminal resource capability information read by the reading subunit 202 to determine whether current resource capabilities of the terminal device are sufficient for executing the scheduled task.

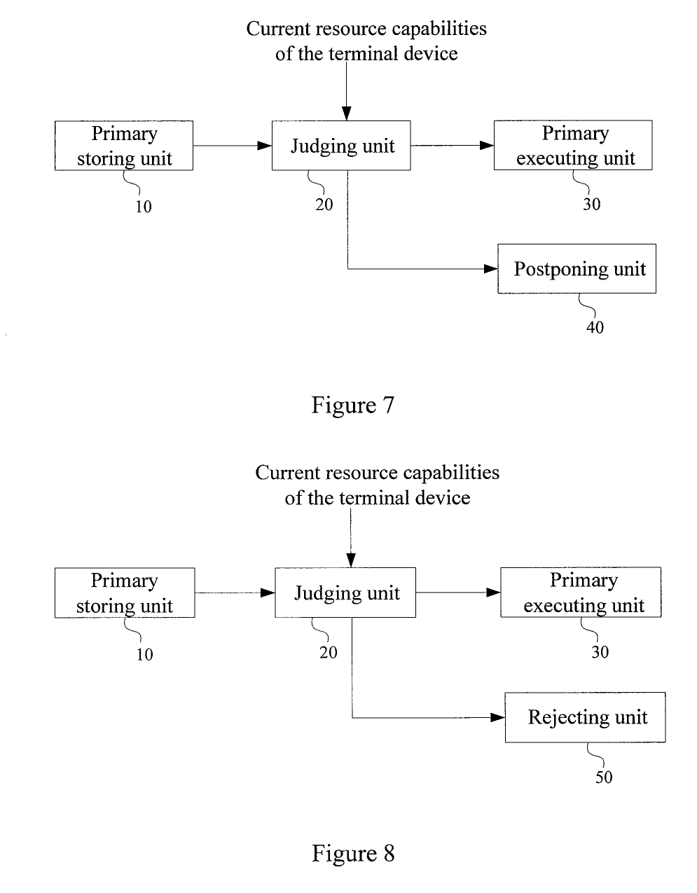

FIG. 7-FIG. 9 respectively show the elements of three types of OMA DM-based terminal devices for several embodiments of the invention. The OMA DM-based terminal devices may further include one of a postponing unit 40, a rejecting unit 50 and a secondary executing unit 60 on the basis of the composition shown in FIG. 5. In FIG. 7, the postponing unit 40 is adapted to postpone executing the scheduled task when the judging unit 20 determines that the current resource capabilities are deficient, and execute the scheduled task as soon as the current resource capabilities of the terminal device are sufficient for executing the scheduled task.

In FIG. 8, the rejecting unit 50 is adapted to reject execution of the scheduled task when the judging unit 20 determines that the current resource capabilities are deficient.

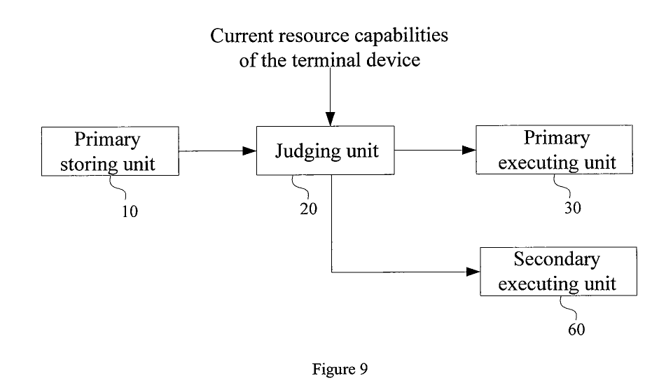

In FIG. 9, the secondary executing unit 60 is adapted to execute the scheduled task as soon as the judging unit 20 determines that the current resource capabilities are deficient, and meanwhile adjust the current resource capabilities of the terminal device to ensure completion of the scheduled task.

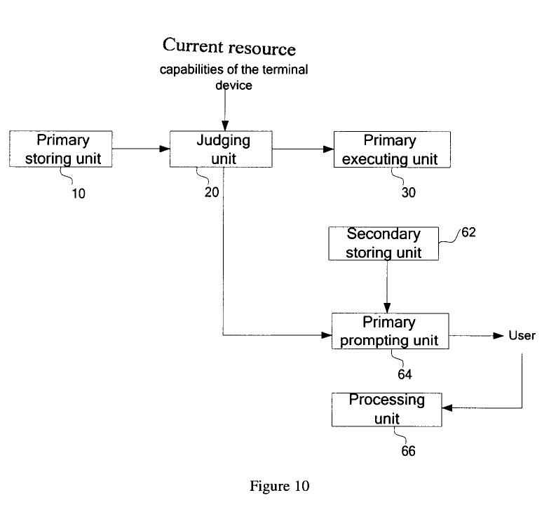

FIG. 10 shows the elements of another type of OMA DM-based terminal device in the another embodiment of the invention, where the terminal device may further include three units on the basis of the composition shown in FIG. 5:

a secondary storing unit 62, adapted to store a group of different processing strategies beforehand, which include but are not limited to postponing executing the scheduled task, rejecting execution of the scheduled task and executing the scheduled task;

a primary prompting unit 64, adapted to prompt the user that the current resource capabilities of the terminal device are deficient for executing the scheduled task when the judging unit 20 determines that the current resource capabilities are deficient, and prompt the user about all the processing strategies pre-stored by the secondary storing unit 62; and

a processing unit 66, adapted to process the scheduled task according to the processing strategy selected by the user.

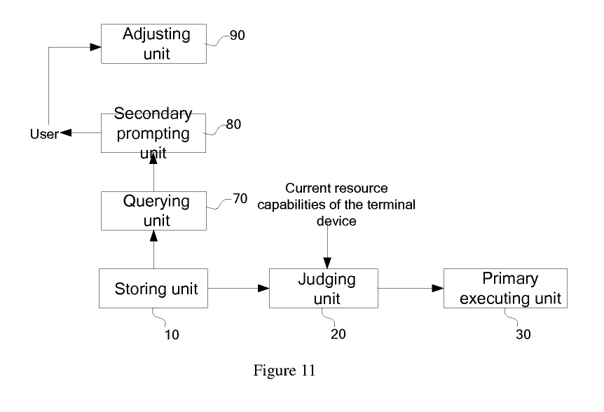

FIG. 11 shows the elements of another type of OMA DM-based terminal device in an embodiment of the invention, in which the user can query the information about the terminal resource capabilities required for executing the scheduled task anytime. The terminal device further includes two units on the basis of the composition shown in FIG. 5:

a querying unit 70, adapted to query the information about the terminal resource capabilities required for executing the scheduled task through a UI of the terminal device while the terminal device is in the period of not executing the scheduled task, in which the information about the terminal resource capabilities is stored in the storing unit 10 beforehand;

a secondary prompting unit 80, adapted to prompt the user about the query results of the querying unit 70; and

an adjusting unit 90, adapted to adjust the current resource capabilities of the terminal device according to the command input by the user so that the scheduled task can be finished normally after the task is triggered.

Other specific technical implementation details of the terminal device proposed by the present invention are not further described, but would be easily determined by one skilled in the art without undue experimentation. For example, the relevant technical implementation details with respect to the method for executing a scheduled task described above may serve as a reference.

By analogy, the terminal resource capabilities required for executing a scheduled task mentioned in the foregoing method are also applicable to the process in which a terminal device executes a management task delivered by a DM server, with a view to improving the success ratio of executing the management tasks delivered by the DM server to the terminal device.

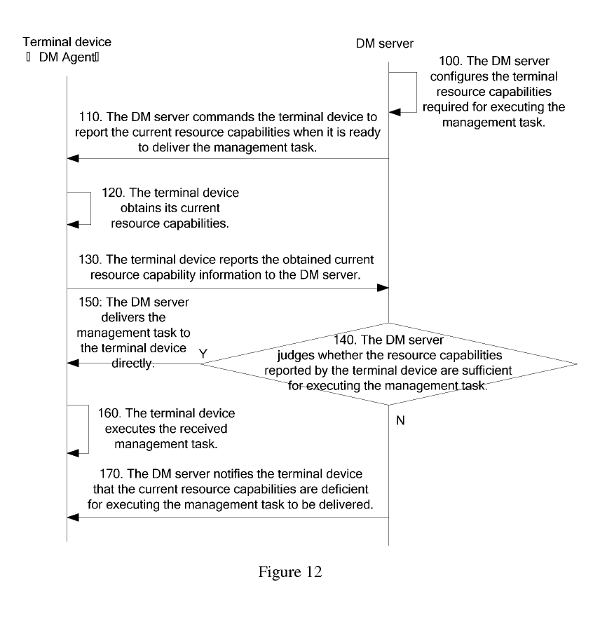

FIG. 12 provides a sequence diagram illustrating a process of implementing the first OMA DM-based method for executing a management task in an embodiment of the invention. The implementation process includes the following steps:

Step 100: The DM server configures the terminal resource capabilities required for executing a generated management task beforehand, where the terminal resource capabilities include but are not limited to at least one of the following attributes:

free memory required for the terminal device to execute a management task (marked as “Memory”);

free electricity required for the terminal device to execute a management task (marked as “Electricity”);

application tool information required for the terminal device to execute a management task (marked as “Tool”);

signal strength required for the terminal device to execute a management task (marked as “Signal_Strength”); and

local time information required for the terminal device to execute a management task (marked as “LocalTime”).

Step 110: While delivering a management task to the terminal device, the DM server commands the terminal device (through a Get command) to report its current resource capabilities, for example, free memory, free electricity, and signal strength.

Step 120: The terminal device responds to the command issued by the DM server, and obtains the current resource capabilities. The terminal device may expand the nodes of the DM tree to store the corresponding resource capability identifiers (for example, Memory identifier, Electricity identifier, Signal_Strength identifier and LocalTime identifier), and may interpret and respond to the command issued by the DM server through the corresponding terminal resource capability identifiers stored on an expanded node. FIG. 3 shows how the terminal device expands its DM tree and stores the corresponding terminal resource capability identifiers on the expanded nodes. Here what are stored on the node are the corresponding terminal resource capability identifiers instead of the values of the terminal resource capabilities required for executing a scheduled task.

Meanwhile, based on the terminal resource capability identifiers stored on the expanded nodes in the DM tree, the terminal device may obtain the current resource capability values of the terminal device from the lower-layer system through system debugging interfaces provided by the lower-layer system of the terminal device.

Step 130: The terminal device reports the obtained current resource capability information to the DM server.

Step 140: The DM server judges whether the current resource capabilities reported by the terminal device meet the preconfigured terminal resource capabilities required for executing the management task. If so, the process goes to step 150; if not, the process goes to step 170.

Step 150: The DM server delivers the management task to the terminal device directly.

Step 160: The terminal device executes the management task delivered by the DM server upon receiving it.

Step 170: The DM server notifies the terminal device that the current resource capabilities of the terminal device are unable to support the management task to be delivered.

Moreover, when the DM server determines that the resource capabilities reported by the terminal device are deficient for executing the management task, the DM server may adjust the management task according to the resource capabilities reported by the terminal device so that the current resource capabilities of the terminal device are sufficient for executing the management task correctly, and then deliver the adjusted management task to the terminal device for execution. This ensures that the terminal device executes the management task delivered by the DM server successfully, thus improving the success ratio of executing management tasks.

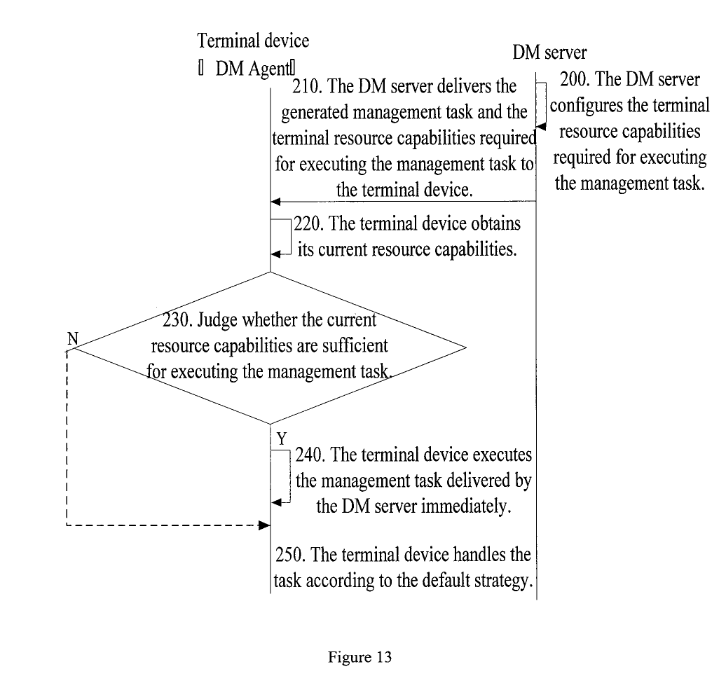

FIG. 13 provides a sequence diagram illustrating the process of implementing a second OMA DM-based method for executing a management task proposed in an embodiment of the invention, including the following steps:

Step 200: The DM server configures the terminal resource capabilities required for executing a generated management task beforehand, where the terminal resource capabilities include but are not limited to at least one of the following attributes:

free memory required for the terminal device to execute a management task (marked as “Memory”);

free electricity required for the terminal device to execute a management task (marked as “Electricity”);

application tool information required for the terminal device to execute a management task (marked as “Tool”);

signal strength required for the terminal device to execute a management task (marked as “Signal_Strength”); and

local time information required for the terminal device to execute a management task (marked as “LocalTime”).

Step 210: The DM server delivers the generated management task and the terminal resource capabilities required for executing the management task to the terminal device; the DM server may also preset a group of terminal resource capability thresholds, and deliver a portion of terminal resource capabilities required for executing the management task to the terminal device, where this portion is greater than the group of terminal resource capability thresholds.

Step 220: When the terminal device receives the management task delivered by the DM server and the terminal resource capabilities required for executing the management task, the terminal device does not choose to execute the received management task immediately, but obtains the current resource capabilities first (as regards how the terminal device obtains its current resource capabilities, see the foregoing descriptions).

Step 230: The terminal device judges whether the current resource capabilities are sufficient for executing the management task. That is, the terminal device compares the obtained current resource capabilities with the terminal resource capabilities required for executing the management task which are delivered by the DM server. In this way, the terminal device knows whether the current resource capabilities can support execution of the management task delivered by the DM server. If so, the process goes to step 240; if not, the process goes to step 250.

Step 240: The terminal device executes the management task delivered by the DM server immediately.

Step 250: The terminal device handles the management task according to the preset default strategies, which may be but are not limited to the following two modes:

(1) The terminal device directly rejects execution of the management task delivered by the DM server, and reports the message of rejecting execution of the management task to the DM server.

(2) The terminal device chooses to execute the management task delivered by the DM server immediately, and adjusts its resource capabilities to ensure completion of the management task.

(3) The terminal device may store a group of different processing strategies beforehand. The processing strategies include but are not limited to: rejecting execution of the management task, and executing the management task.

Subsequently, when the terminal device intends to execute the management task delivered by the DM server, if it determines that the current resource capabilities are deficient for executing the management task, it prompts the user that the current resource capabilities are deficient, and prompts the user about the processing strategies stored beforehand. According to the processing strategy selected by the user, the terminal device handles the management task delivered by the DM server. If the user chooses to reject execution of the management task, the terminal device rejects execution of the management task delivered by the DM server upon receiving the command input by the user.

In the following embodiment of the invention, a process of implementing the method for executing a management task is described in detail, supposing that a management task is executed in light of the required terminal resource capabilities in the scenario of downloading a software component:

Suppose a DM server intends to deliver a management task: the task is to download and install a software component to a terminal device; the free memory for installing the software component is 0.8 MB, and the predicted download duration is 2-3 minutes.

To ensure that the management task is executed by the terminal device successfully, the DM server commands the terminal device to report the current resource capabilities before delivering the management task. The DM server uses the SyncML language currently compliant with the OMA DM protocol to command the terminal device to report the current resource capability information. The specific commands and reported results are as follows:

The commands issued by the DM server are:

```
<Get>
  <CmdID>4</CmdID>
  <Item>
    <Target>
      <LocURI>./.../ENV_REQ/ Memory</LocURI>
    </Target>
  </Item>
  <Item>
    <Target>
      <LocURI>./.../ENV_REQ/Electricity</LocURI>
    </Target>
  </Item>
</Get>
The results reported by the terminal device are:
<Results>
  <MsgRef>1</MsgRef><CmdRef>4</CmdRef>
  <CmdID>3</CmdID>
  <Item>
    <Source>
      <LocURI>./.../ENV_REQ/Memory</LocURI>
    </Source>
    <Data>0.6</Data>
    </Item>
    <Item>
      <Source>
        <LocURI>./.../ENV_REQ/Electricity </LocURI>
      </Source>
    <Data>0.6</Data>
  </Item>
</Results>
```

The DM server judges whether the current resource capabilities reported by the terminal device are sufficient for executing the management task, and determines that: the free memory size in the terminal device is currently too small (0.6 MB, less than the free memory required for installing the software component delivered by the DM server, namely 0.8 MB).

The DM server prompts the user that the current free memory of the terminal device is deficient for installing the software component delivered by the DM server.

According to the first OMA DM-based method for executing a management task mentioned above, the present invention also provides a DM server, including: a configuring unit, adapted to configure the terminal resource capabilities required for executing the management task; a command unit, adapted to command the terminal device to report the current resource capabilities before the management task is delivered to the terminal device; a judging unit, adapted to judge whether the current resource capabilities reported by the terminal device are sufficient for executing the management task; and a primary task delivering unit, adapted to deliver the management task to the terminal device for execution when the judging unit determines that the current resource capabilities are sufficient.

Preferably, the DM server may also include: a management task adjusting unit, adapted to adjust the management task to be delivered so that the current resource capabilities of the terminal device are sufficient for executing the management task correctly; and a secondary management task delivering unit, adapted to deliver the management task adjusted by the management task adjusting unit to the terminal device for execution.

Preferably, the DM server may also include a notifying unit, adapted to notify the terminal device that the current resource capabilities do not support execution of the management task to be delivered after the judging unit determines that the current resource capabilities are deficient.

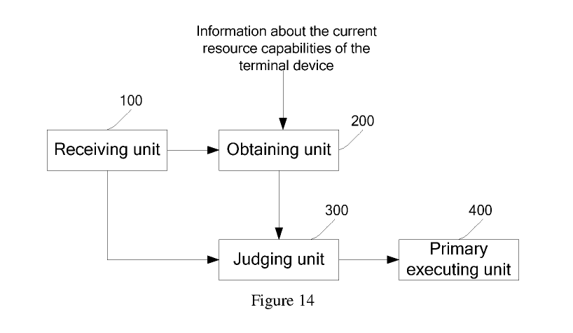

According to the second method for executing a management task mentioned above, the present invention also provides a terminal device. FIG. 14 shows the elements of another type of OMA DM-based terminal device proposed in an embodiment of the invention. The elements include:

a receiving unit 100, adapted to receive the management task delivered by the DM server and the terminal resource capabilities required for executing the management task;

an obtaining unit 200, adapted to obtain the current resource capability information of the terminal device when the receiving unit 100 receives the management task and the terminal resource capabilities required for executing the management task;

a judging unit 300, adapted to judge whether the current resource capabilities obtained by the obtaining unit 200 meet the terminal resource capabilities that are required for executing the management task and received by the receiving unit 100; and

a primary executing unit 400, adapted to execute the management task delivered by the DM server as soon as the judging unit determines that the current resource capabilities are sufficient.

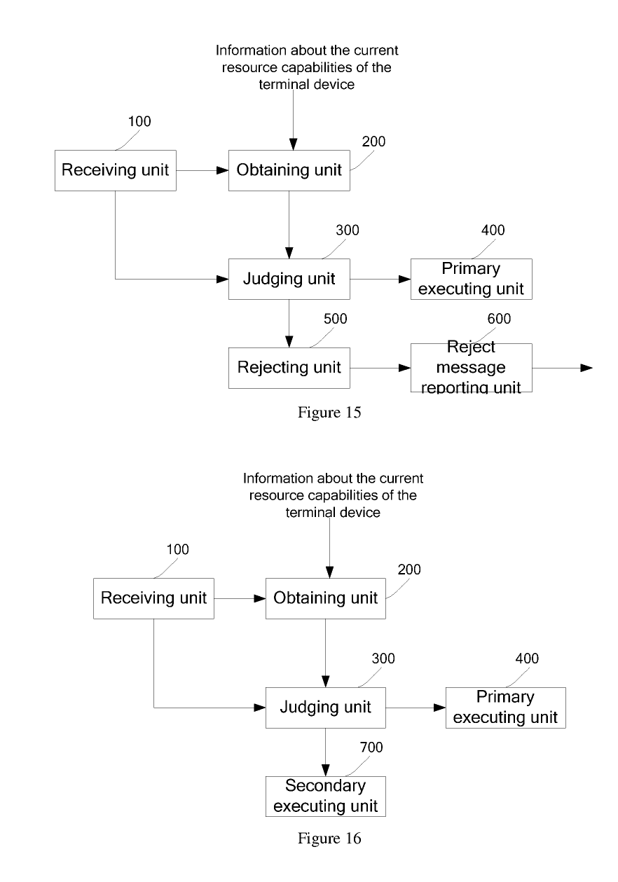

FIG. 15 shows the elements of another type of OMA DM-based terminal device in an embodiment of the invention. The terminal device further includes two units on the basis of the composition shown in FIG. 13:

a rejecting unit 500, adapted to reject execution of the management task delivered by the DM server as soon as the judging unit 300 determines that the current resource capabilities are deficient; and

a reject message reporting unit 600, adapted to report to the DM server that the rejecting unit 500 rejects execution of the management task.

FIG. 16 shows the elements of another type OMA DM-based terminal device in an embodiment of the invention. On the basis of the composition shown in FIG. 13, the terminal device further includes a secondary executing unit 700, adapted to execute the management task delivered by the DM server when the judging unit 300 determines that the current resource capabilities are deficient, and to adjust the resource capabilities of the terminal device to ensure completion of the management task.

Other specific technical implementation details of the terminal device proposed by the present invention are not further described, but would be easily determined by one skilled in the art without undue experimentation. For example, the relevant technical implementation details with respect to the second method for executing a management task described above may serve as a reference.

In the foregoing schemes, the terminal device may, for example, obtain its current resource capability values in the following two modes:

(1) Expand the nodes of the DM tree in the terminal device beforehand, and store the corresponding terminal resource capability identifiers on the expanded nodes; obtain a terminal resource capability value from the lower-layer system through an interface provided by the lower-layer system when the terminal device receives a Get command to obtain the current resource capabilities based on the terminal resource capability identifier stored on the corresponding expanded node in the DM tree.

A terminal device may derive from the first mode, including: a unit adapted to expand the nodes of the DM tree in the terminal device and store the corresponding terminal resource capability identifiers on the expanded nodes; and a unit adapted to obtain a terminal resource capability value from the lower-layer system through an interface provided by the lower-layer system based on the terminal resource capability identifier stored on the corresponding expanded node in the DM tree.

(2) The terminal device expands the nodes of the DM tree beforehand, and stores the corresponding terminal resource capability values on the expanded nodes. Afterward, the terminal device directly obtains the corresponding terminal resource capability values on its own expanded nodes in the DM tree. Based on this mode, the terminal device needs to update the changed resource capability value onto the corresponding expanded node in the DM tree if a terminal resource capability value changes.

Although the invention has been described through some exemplary embodiments, the invention is not limited to such embodiments. It is apparent that those skilled in the art can make various modifications and variations to the present invention without departing from the spirit and scope of the present invention. Accordingly, it is expressly intended that all such variations, changes and foreseeable equivalents which fall within the spirit and scope of the present invention as defined in the claims, be embraced thereby.

What is claimed is:

1. A method for executing a device management (DM) task, wherein the DM task comprises a scheduled task or a management task, comprising the steps of:
receiving a DM task and terminal resource capabilities required for executing the DM task;
obtaining current resource capabilities of a terminal device;
judging whether the current resource capabilities meet the terminal resource capabilities required for executing the DM task; and
executing the DM task if determining that the current resource capabilities meet the terminal resource capabilities required for executing the DM task.

2. The method of claim 1, further comprising the step of:
storing the terminal resource capabilities required for executing the DM task in the form of a DM tree.

3. The method of claim 1, further comprising the step of:
postponing executing the scheduled task upon determining that the current resource capabilities do not meet the terminal resource capabilities required for executing the DM task, when the DM task comprises a scheduled task.

4. The method of claim 1, further comprising the step of:
rejecting execution of the DM task upon determining that the current resource capabilities do not meet the terminal resource capabilities required for executing the DM task.

5. The method of claim 1, further comprising the steps of:
executing the scheduled task; and
adjusting the resource capabilities to ensure completion of the DM task.

6. The method of claim 1, further comprising the steps of:
storing a group of different processing strategies; and
providing user notification that the current resource capabilities are deficient for executing the DM task if the current resource capabilities do not meet the terminal resource capabilities required for executing the DM task;
providing user notification in regard to stored processing strategies;
receiving a user-selected processing strategy; and
processing the DM task according to the user-selected processing strategy.

7. The method of claim 1, wherein when the DM task comprises a scheduled task, the method further comprises the steps of:
querying the stored terminal resource capabilities required for executing the scheduled task through a User Interface (UI) while the terminal device is in the period of not executing the scheduled task; and
displaying the query results to a user; and
adjusting the current resource capabilities according to a command input by the user.

8. The method of any of the claim 1, wherein the judgment process further comprises the steps of:
judging whether the current resource capabilities are sufficient for executing the DM task by comparing the obtained current resource capabilities with the stored terminal resource capabilities required for executing the DM task; and
determining that the current resource capabilities meet the terminal resource capabilities required for executing the DM task when the current resource capabilities are sufficient for executing the DM task.

9. A method for executing a device management (DM) task, wherein the DM task comprises a scheduled task or a management task, the method comprising the steps of:
generating terminal resource capabilities required for executing a DM task; and
delivering the DM task and the generated terminal resource capabilities to a terminal device; wherein the terminal resource capabilities are compared with current resource capabilities of the terminal device by the terminal device to determine whether to execute the DM task.

10. The method of claim 9, further comprising the step of: updating the terminal resource capabilities stored in the terminal device in the OTA mode.

11. A terminal device, comprising:
a receiving unit, adapted to receive a device management (DM) task and the terminal resource capabilities required for executing the DM task, wherein the DM task comprises a scheduled task or a management task;
a judging unit, adapted to judge whether the current resource capabilities of the terminal device meet the terminal resource capabilities required for executing the DM task received from the receiving unit; and
a primary executing unit, adapted to execute the DM task when the judging unit determines that the current resource capabilities meet the terminal resource capabilities required for executing the DM task.

12. The terminal device of claim 11, the terminal device further comprising: a primary storing unit, adapted to store the terminal resource capabilities required for executing the DM task received by the receiving unit.

13. The terminal device of claim 11, the terminal device further comprising: a postponing unit, adapted to postpone executing the scheduled task when the judging unit determines that the current resource capabilities do not meet the terminal resource capabilities required for executing the scheduled task, when the DM task comprises a scheduled task.

14. The terminal device of claim 11, further comprising: a rejecting unit, adapted to reject execution of the DM task when the judging unit determines that the current resource capabilities do not meet the terminal resource capabilities required for executing the DM task.

15. The terminal device of claim 11, comprising: a secondary executing unit, adapted to execute the DM task when the judging unit determines that the current resource capabilities do not meet the terminal resource capabilities required for executing the DM task, and to adjust the resource capabilities of the terminal device to ensure completion of the DM task.

16. The terminal device of claim 11, further comprising:
a secondary storing unit, adapted to store a group of different processing strategies;
a primary prompting unit, adapted to notify the user that the current resource capabilities of the terminal device do not meet the terminal resource capabilities required for executing the DM task when the judging unit determines that the current resource capabilities do not meet the terminal resource capabilities required for executing the DM task, and to notify the user about processing strategies pre-stored by the secondary storing unit; and
a processing unit, adapted to process the DM task according to a processing strategy selected by the user.

17. The terminal device of claim 11, wherein the primary storing unit stores the terminal resource capabilities required for executing the DM task in the form of a DM tree.

18. The terminal device of claim 11, wherein the judging unit comprises:
an obtaining subunit, adapted to obtain the current resource capabilities of the terminal device;
a reading subunit, adapted to read the terminal resource capabilities that are required for executing the DM task and stored in the primary storing unit; and
a comparing subunit, adapted to compare the resource capabilities obtained by the obtaining unit with the terminal resource capabilities read by the reading subunit to determine whether the current resource capabilities of the terminal device are sufficient for executing the DM task.

19. The terminal device of claim 11, further comprising:
a querying unit, adapted to query information about the terminal resource capabilities required for executing the DM task through a User Interface, UI, while the terminal device is in the period of not executing the DM task, where the information is stored in the primary storing unit;
a secondary prompting unit, adapted to notify the user about the query results of the querying unit; and
an adjusting unit, adapted to adjust the current resource capabilities of the terminal device according to the command input by the user.

20. A method for executing a management task, comprising the steps of:
configuring terminal resource capabilities required for executing the management task;
commanding a terminal device to report current resource capabilities of the terminal device before delivering the management task to the terminal device;
obtaining the current resource capabilities reported by the terminal device; and
delivering the management task to the terminal device for execution upon determining that the current resource capabilities reported by the terminal device are sufficient for executing the management task.

21. The method of claim 20, further comprising the steps of:
adjusting the management task to be delivered according to the current resource capabilities reported by the terminal device so that the current resource capabilities are sufficient for executing the management task correctly when determining that the current resource capabilities reported by the terminal device are deficient for executing the management task; and
delivering the adjusted management task to the terminal device for execution.

22. The method of claim 20, further comprising the step of:
notifying the terminal device that the current resource capabilities do not support execution of the management task to be delivered in response to determining that the current resource capabilities reported by the terminal device are deficient for executing the management task.

23. The method of claim 20, wherein the terminal device interprets and responds to the command by expanding the nodes of the DM tree stored in the terminal device and storing the corresponding terminal resource capability identifiers on the expanded nodes.

24. A DM server, comprising:
a configuring unit, adapted to configure terminal resource capabilities required for executing a management task;
a command unit, adapted to command the terminal device to report a current resource capabilities of the terminal device when intending to deliver the management task to the terminal device;
a judging unit, adapted to judge whether the current resource capabilities reported by the terminal device are sufficient for executing the management task; and
a primary management task delivering unit, adapted to deliver the management task to the terminal device for execution when the judging unit determines that the current resource capabilities are sufficient.

25. The DM server of claim 24, further comprising:
a management task adjusting unit, adapted to adjust the management task to be delivered according to the current resource capabilities reported by the terminal device so that the current resource capabilities are sufficient for executing the management task correctly when the judging unit determines that the current resource capabilities are deficient; and
a secondary management task delivering unit, adapted to deliver the management task adjusted by the management task adjusting unit to the terminal device for execution.

26. The DM server of claim 24, further comprising:
a notifying unit, adapted to notify the terminal device that the current resource capabilities do not support execution of the management task to be delivered when the judging unit determines that the current resource capabilities are deficient.

27. A method for obtaining terminal resource capabilities, comprising the steps of:
expanding the nodes of a DM tree in a terminal device;
storing the corresponding terminal resource capability identifiers on the expanded nodes; and
obtaining, by the terminal device, a corresponding terminal resource capability value from a lower-layer system through an interface provided by the lower-layer system, based on the corresponding terminal resource capability identifier stored on an expanded node in the DM tree.

28. An OMA DM-based terminal device, comprising:
a unit, adapted to expand the nodes of a DM tree in the terminal device and store the corresponding terminal resource capability identifiers on the expanded nodes; and
a unit, adapted to obtain the corresponding terminal resource capability value from a lower-layer system through an interface provided by the lower-layer system of the terminal device, based on the corresponding terminal resource capability identifier stored on an expanded node in the DM tree.

29. A computer program product, comprising computer program code, which, when executed by a computer unit, causes the computer unit to perform the steps of claim 1.
